(19) United States
(12) Patent Application Publication
(10) Pub. No.: US 2015/0012664 A1
(43) Pub. Date: Jan. 8, 2015

(54) ROUTING DATA BASED ON A NAMING SERVICE

(71) Applicant: Cisco Technology, Inc., San Jose, CA (US)

(72) Inventor: Matt Johnson, London (GB)

(21) Appl. No.: 13/934,695

(22) Filed: Jul. 3, 2013

(51) Int. Cl. H04L 12/721

(52) U.S. Cl. CPC H04L 45/72
USPC 709/238

(57) ABSTRACT

In one embodiment, a first packet, which identifies a domain name, is received as a content request from a source device in a network. Also, a second packet, which identifies an Internet Protocol (IP) address associated with the domain name, is received as a response to the content request from a domain name system (DNS) server. A DNS policy-based routing (DNS-PBR) list that lists one or more domain names is then accessed. The DNS-PBR list defines a routing policy based on a corresponding listed domain name. According to the DNS-PBR list, a routing policy that corresponds to the domain name is determined. Then, a routing decision is made based on the routing policy.

### TECHNICAL FIELD

The present disclosure relates generally to computer networks, and, more particularly, to routing data based on a naming service.

### BACKGROUND

With the borders of data infrastructure becoming blurred due to the rapidly growing interest in outsourcing computing processes to the cloud or content distribution networks, it becomes more difficult to manage the best paths of myriad online services belonging to a company or an individual. This is further exacerbated in the case of small and medium-size enterprises (SMEs), where multiple business locations can place a centrally-located IT department in the undesirable position of ensuring the best data path out of each office location for users and infrastructure traffic. In addition, IP addresses, which numerically label devices participating in a computer network, may change as content is outsourced or migrated between private, public, or semi-public networks.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example simplified communication network;

FIG. 2 illustrates an example network device/node;

FIG. 3 illustrates an example schematic view of domain name system policy-based routing (DNS-PBR) in the communication network;

FIG. 4 illustrates an example simplified schematic view of the network device;

FIG. 5 illustrates an example partial view of the communication network where the network device includes a primary and secondary WAN access port; and

FIG. 6 illustrates an example simplified procedure for routing data based on a naming service in the communication network.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DESCRIPTION OF EXAMPLE EMBODIMENTS

### Overview

According to one or more embodiments of the disclosure, a first packet, which identifies a domain name, is received as a content request from a source device in a network. Also, a second packet, which identifies an Internet Protocol (IP) address associated with the domain name, is received as a response to the content request from a domain name system (DNS) server. A DNS policy-based routing (DNS-PBR) list that lists one or more domain names is then accessed. The DNS-PBR list defines a routing policy based on a corresponding listed domain name. According to the DNS-PBR list, a routing policy that corresponds to the domain name is determined. Then, a routing decision is made based on the routing policy.

### Description

A computer network is a geographically distributed collection of nodes interconnected by communication links and segments for transporting data (e.g., voice, video, and/or data) between end nodes, such as personal computers and workstations, portable computers (e.g., laptops, tablets, etc.), smartphones, or other devices, such as sensors, etc. Many types of networks are available, ranging from Local Area Networks (LANs) to Wide Area Networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, Synchronous Optical Networks (SONET), Synchronous Digital Hierarchy (SDH) links, etc.

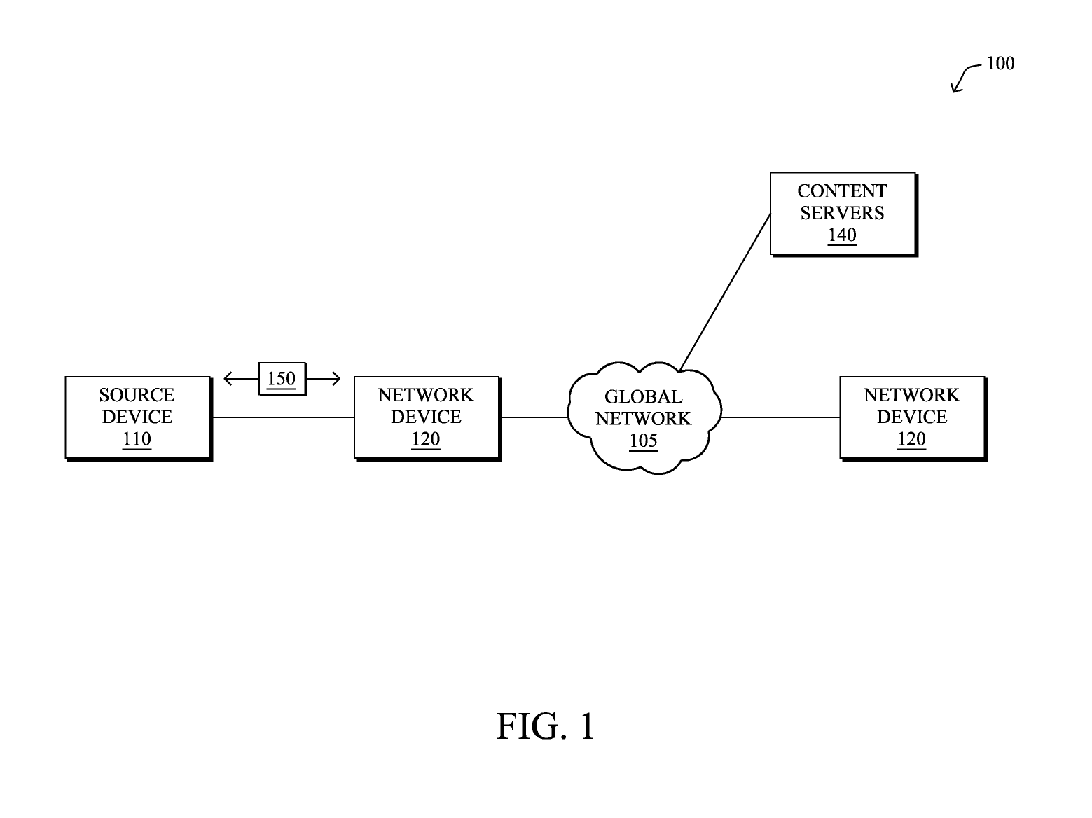

FIG. 1 is a schematic block diagram of an example simplified communication network 100 illustratively including various interconnected network devices (e.g., computers, servers, routers, etc.), which may form local networks or LANs (e.g., homes, schools, businesses, etc.) that are interconnected by a global network (e.g., the public Internet) or WAN 105. Illustratively, source device 110 may interconnect at various times with a network device (e.g., locational router) 120, such as a home wireless router, a business wired router, etc. Various servers 130/140, such as notification servers, service provider servers, etc., may be interconnected with the global network 105 (and/or within respective local networks). In particular, domain name system (DNS) server 130, e.g., DNS name server, and content server(s) 140 may connect to the network device 120 and source device 110 via the WAN 105. It should be understood that any suitable number of network devices may be implemented in the network 100, that the network devices may be interconnected with one another in any suitable configuration, and that the view shown herein is merely for the purpose of simplicity.

The links between the network devices may generally be wired or wireless. Data packets (or frames) 150 may be exchanged among the devices of the computer network 100 over the links using predefined network communication protocols such as certain known wired protocols, wireless protocols, or other protocols where appropriate. In this context, a protocol consists of a set of rules defining how the nodes interact with each other. In general, the connections to/from and between the networks may comprise IPv4 and/or IPv6 (or one or more translations between the two), without being specifically distinguished herein. Those skilled in the art will further understand that while the network is shown using a certain device naming convention, the network 100 and the device names are merely an example illustration that is not meant to limit the disclosure.

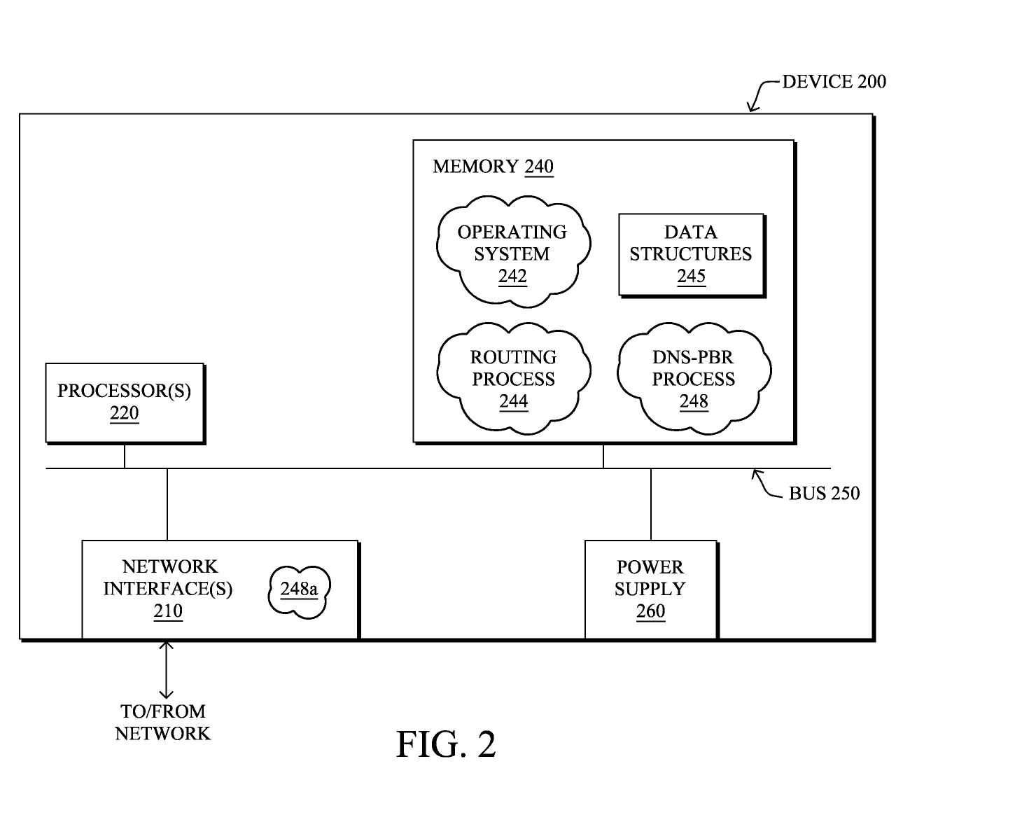

FIG. 2 is a schematic block diagram of an example node/device 200 that may be used with one or more embodiments described herein, e.g., as shown in FIG. 1. In particular, the illustrated device 200 may schematically represent a simplified configuration of the network device (e.g., router) 120. The device may comprise one or more network interfaces 210 (e.g., wireless/channel-hopping), at least one processor 220, a memory 240, and a power supply 260 (e.g., plug-in, battery, etc.), all of which may be interconnected by a system bus 250.

The network interface(s) 210, e.g., transceivers, contain the mechanical, electrical, and signaling circuitry for communicating data over the communication links coupled to the network 100, as shown in FIG. 1. The network interfaces may be configured to transmit and/or receive data using a variety of different communication protocols. It should be understood that the device 200 may have multiple different types of network interfaces 210, e.g., wireless and wired/physical connections, and that the view herein is merely for illustration.

The memory 240 comprises a plurality of storage locations that are addressable by the processor(s) 220 and the network interface(s) 210 for storing software programs and data structures associated with the embodiments described herein. Note that certain devices may have limited memory or no memory (e.g., no memory for storage other than for programs/processes operating on the device). The processor(s) 220 may comprise necessary elements or logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise routing process/services 244 and an illustrative domain name system policy-based routing, e.g., “DNS-PBR,” process 248, as described herein. Note that while the DNS-PBR process 248 is shown in centralized memory 240, alternative embodiments provide for the process, or portions thereof, to be specifically operated within the network interfaces 210, such as a component of a MAC layer (process “248a”). For the purposes of the present disclosure, the stored data structures 245 may include various useful information to be accessed and/or manipulated by the software processes, including, for example, a routing table and a DNS-PBR configuration file.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process/services 244 contain computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a routing/forwarding information database (e.g., a data structure 245) containing, e.g., data used to make routing/forwarding decisions. In particular, changes in the network topology may be communicated among devices in the computer network using routing protocols, such as the conventional OSPF and IS-IS link-state protocols (e.g., to “converge” to an identical view of the network topology). Notably, routing services 244 may also perform functions related to virtual routing protocols, such as maintaining VRF instances (not shown), or tunneling protocols, such as for Multi-Protocol Label Switching (MPLS), generalized MPLS (GMPLS), etc., each as will be understood by those skilled in the art.

As noted above, interest in outsourcing computing processes to the cloud or content distribution networks continues to grow. It thus becomes more difficult for a company or individual to manage the best paths of myriad online services. Client devices can access online services, content, devices, etc. via the domain name system (DNS). The DNS is a hierarchical distributed naming system for devices participating in the Internet or a private network. The system associates certain information with domain names assigned to each of the participating entities. In particular, easily recalled domain names are translated to numerical IP addresses for the purpose of accessing remote services and/or content.

s For example, the domain name “www.example.com” may translate to the IP addresses 192.0.43.10 (IPv4) and 2001:500:88:200::10 (IPv6). This domain name-IP address association is recorded, and may be recalled by a client device, using the DNS. Notably, a DNS name server, e.g., DNS server 130, stores the DNS records for a domain name, including, for example, the corresponding IP address. The DNS name server responds to DNS queries against its database with a response which identifies a corresponding IP address.

After identifying the proper IP address, a router, e.g., network device 120, may select a route from the client device, e.g., source device 110, to the destination. The router may base its routing decision on a routing protocol, which specifies how network devices communicate with each other. In particular, the routing protocol determines the route between the network devices used for the transfer of data packets. One such routing protocol is known as policy-based routing (PBR), which a technique used for making routing decisions based on policies set by a network administrator. According to standard routing protocols, when a router receives a packet, the router decides where to forward it based on a destination address included in the packet. The destination address is then used to look up an entry in a routing table.

However, in certain cases, a packet may need to be forwarded based on some other criteria, such as the source address, packet size, or TCP port numbers, for example. The specialized routing criteria may be established as a “policy” by the network administrator. The policy may be set based on the specific needs of the computer network, thus making PBR a highly versatile and adaptable routing protocol.

Notably, many domain names may have hundreds of servers across the Internet, each with its own IP address which are unknown to the administrator of a local configuration. Moreover, IP addresses often change too frequently to make recording them in a list, e.g., in the case of IP-based PBR, feasible or worthwhile.

Dynamic Enabling of Routers

The techniques herein allow for the ability to create custom routing policies based on a DNS domain name, and therefore removes the need to know the IP addresses which make up an internet service or location. The embodiments further allow a wider scope of policy-based routing use, as destinations operated by third parties can be reliably identified, regardless of remote party IP changes or dynamic addressing due to content distribution networks or other outsourced platforms. For instance, the techniques herein pair the flexibility of PBR with domain names, which rarely change, allowing a networking/IT team to have greater control over outgoing routes to destinations—especially where the destinations are located in different branch locations, or even in a completely unrelated company located somewhere else on the public WAN.

Specifically, according to one or more embodiments of the disclosure as described in detail below, a first packet, which identifies a domain name, is received as a content request from a source device in a network. Also, a second packet, which identifies an Internet Protocol (IP) address associated with the domain name, is received as a response to the content request from a domain name system (DNS) server. A DNS policy-based routing (DNS-PBR) list that lists one or more domain names is then accessed. The DNS-PBR list defines a routing policy based on a corresponding listed domain name.

According to the DNS-PBR list, a routing policy that corresponds to the domain name is determined. Then, a routing decision is made based on the routing policy.

Illustratively, the techniques described herein may be performed by hardware, software, and/or firmware, such as in accordance with the “DNS-PBR” process 248/248a, which may contain computer executable instructions executed by the processor 220 (or independent processor of interfaces 210) to perform functions relating to the techniques described herein, e.g., in conjunction with routing process 244. For example, the techniques herein may be treated as extensions to conventional protocols, such as the various wireless communication protocols, and as such, may be processed by similar components understood in the art that execute those protocols, accordingly.

Operationally, the disclosed embodiments provide a mechanism of dynamically routing data destined for certain locations based on widely understood DNS domain names, e.g., “example.com,” instead of a list of IP addresses related to that destination, which are often subject to change. DNS-PBR enables policy-based routing decisions of a much larger scope of destinations, while eliminating the need to constantly update underlying WAN address information for remote locations, which would otherwise be necessary to keep the policy-based routing working properly.

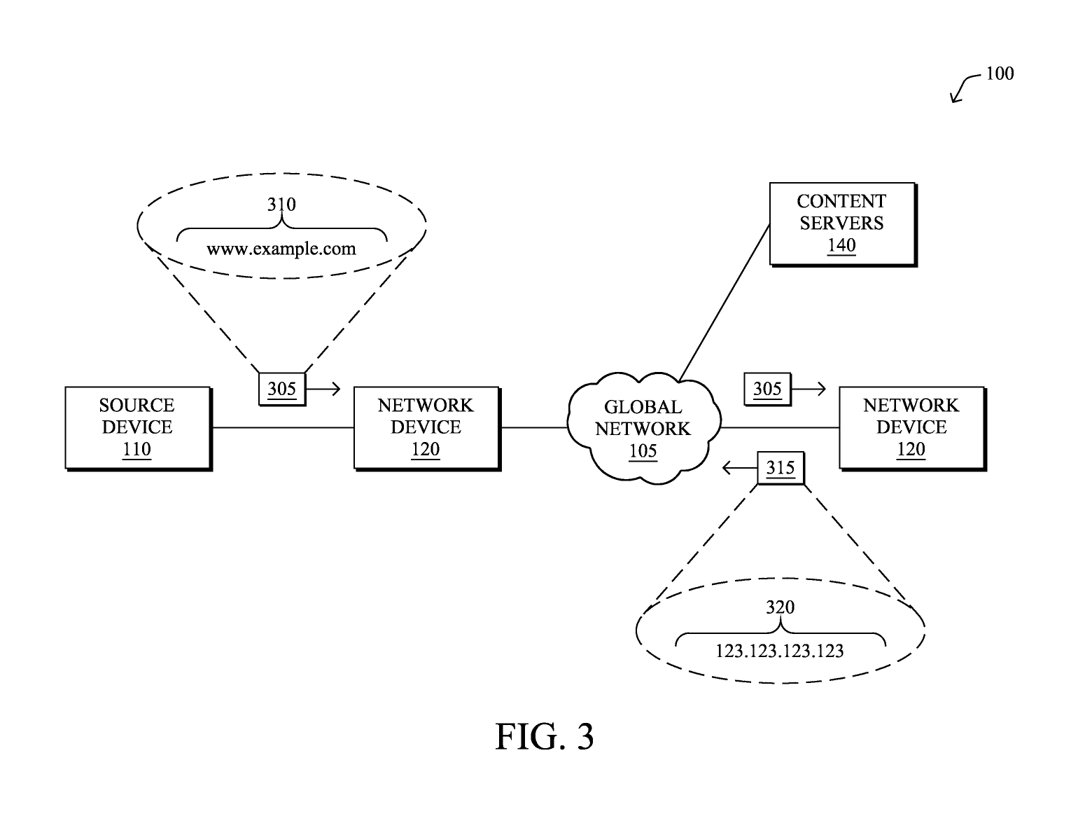

FIG. 3 illustrates an example schematic view of domain name system policy-based routing (DNS-PBR) in the communication network. As shown in FIG. 3, the network 100 includes multiple interconnected devices configured as described in detail above with reference to FIG. 1.

The network device, e.g., router, 120 may receive a DNS request 305, as a “content request,” from the source device, e.g., client, 110. For the purposes of the present disclosure, the DNS request 305 may be considered a “first packet.” The DNS request 305 may include, for, a domain name section 310. The contents of the domain name section 310 may contain a domain name identifying the domain, e.g., “www.example.com.” The domain name may be inputted by a user on the source device 110 via a web browser, for example. The DNS request may include additional information, including, for example, a source address section (not shown). The contents of the source address section may include a source device identifier, i.e., the IP address of the source device 110, which identifies the source device as the source of the DNS request 305.

After receiving the DNS request packet 305, the network device 120 may forward the DNS request toward the DNS server 130. The DNS request 305 still includes the domain name section, as well as additional information, such as a source address section. In addition, or as an alternative, the network device 120 may generate a second DNS request (not shown) based on the DNS request 305, whereby the second DNS request may include extra information, including, for example, an identifier to indicate the location of the network device.

The DNS server 130 may receive the DNS request 305 from the network device 120 via the WAN 105. The DNS server 130 may then resolve the domain name field, e.g., “www.example.com,” contained within the domain name section 310 of the DNS request 305, into an IP address of a destination device, e.g., content server(s) 140, which is capable of providing content identified by the domain name. The DNS server 22 may then generate and transmit a DNS response 315 including, in a target IP address section 320, the IP address of the appropriate content server 140.

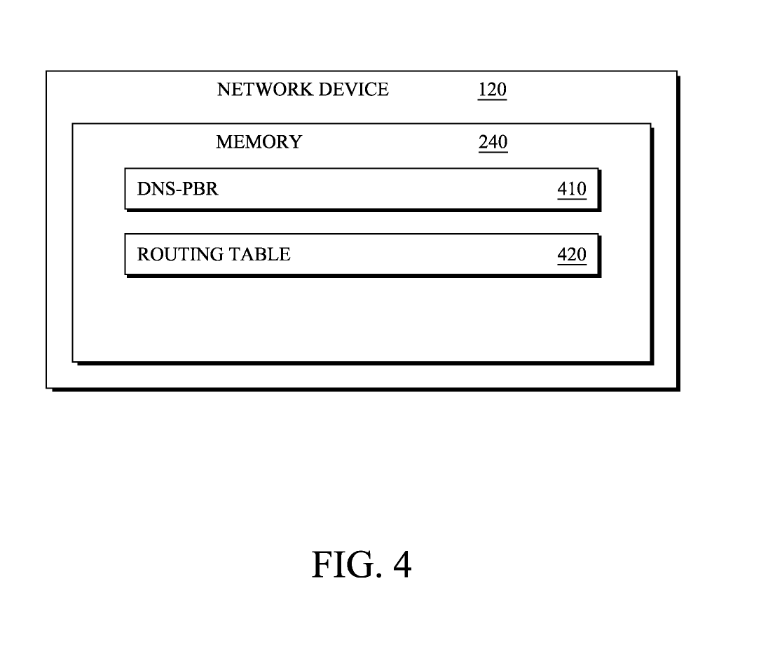

The network device 120 may receive the DNS response 315, as a “response to the content request,” from the DNS server 130. For the purposes of the present disclosure, the DNS response 315 may be considered a “second packet.” Upon receiving the DNS response 315, the network device 120 may inspect the contents of the packet using DNS inspection, in order to access the domain name contained therein. Then, the network device 120 may compare that domain name to others listed in a stored DNS-PBR list, as described in further detail with respect to FIG. 4.

FIG. 4 illustrates an example simplified schematic view of the network device. As shown in FIG. 4, the network device 120 includes a memory 240, as shown in FIG. 2. Further, the memory 240 stores an example DNS-PBR list 410 and routing table 420, which are utilized by the network device 120 in order to perform the DNS-PBR.

After receiving the DNS response 315 and determining the domain name identified in the domain name section 310, the network device 120 may access the DNS-PBR list 410 from memory 240. The DNS-PBR list 410 lists one or more domain names and defines a routing policy based on a corresponding listed domain name. Then, the network device 120 may determine a routing policy that corresponds to the domain name, according to the DNS-PBR list 410.

In particular, the network device 120 may determine whether the domain name is listed in the DNS-PBR list 410. If the domain name, e.g., “www.example.com,” is not listed in the DNS-PBR list 410, the network device 120 may follow a default routing policy. In other words, only normal router actions may occur at this point. In such a case, it may be possible that the network administrator opted to not include the domain name in its configuration, since it is unnecessary to follow a specialized policy when accessing content from that domain name.

On the other hand, if the domain name is listed in the DNS-PBR list 410, the network device 120 may follow a specialized routing policy defined by the DNS-PBR list. In this regard, when a requested domain name is located in the DNS-PBR list 410, the network device 120 may access the routing table 420 from memory 240, whereby the routing table is associated with the source device 110. As is understood by those of ordinary skill in the art, the routing table is a data table stored in a router, or other network device, that lists routes from a source to network destinations. Additional metrics associated with the routes, e.g., distances, may also be recorded in the table. The construction of a routing table is typically the primary goal of the active routing protocol.

After accessing the stored routing table 420, the network device 120 may add, to the routing table, the IP address and a corresponding route from the source device 110 to the IP address. Additionally, the network device 120 may add, to the routing table, a time-to-live (TTL) value associated with the corresponding route. The TTL value may be of a slightly lower value, e.g., in seconds, than the TTL value of the DNS response 315. Thus, it may be ensured that the DNS-PBR will verify this information with external DNS data again before the current DNS data changes/becomes invalid.

The DNS response 315, which includes the IP address identified in the target IP address section 320, may then be forwarded from the network device 120 to the source device 110. When the source device 110 receives the DNS response 315, the source device may connect to the IP address associated with the inputted domain name through the network device.

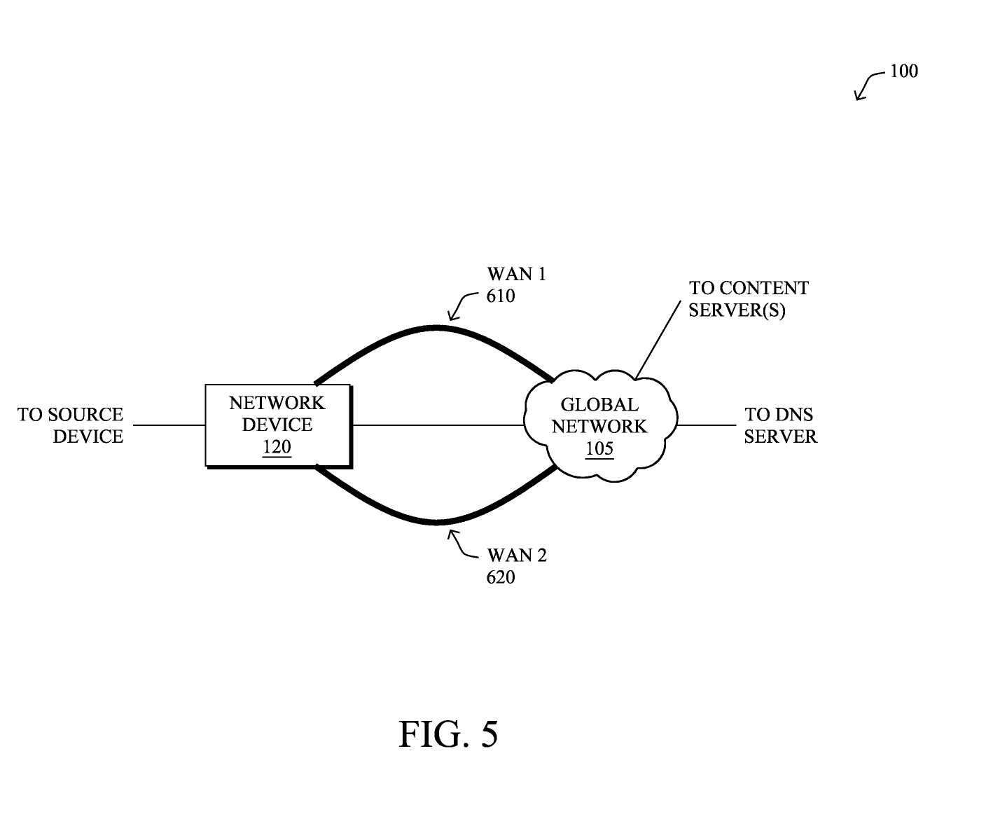

FIG. 5 illustrates an example partial view of the communication network where the network device includes a primary and secondary WAN access port. As shown in FIG. 5, the network 100 includes multiple interconnected devices configured as described in detail above with reference to FIG. 1.

The network device 120 may include multiple external WAN ports. Illustratively, the network device 120 includes a primary external WAN gateway (WAN1) 610 and a secondary external WAN gateway (WAN2) 620.

Importantly, the network administrator may configure multiple outbound routes, e.g., to segregate default traffic (that is, traffic stemming from domain names not listed in the DNS-PBR list 410) from policy-based traffic (that is, traffic stemming from domain names which are listed in the DNS-PBR list 410). In particular, the network administrator may configure a first outbound route for standard/default traffic via WAN1 610, while configuring a second outbound route for policy-based traffic via WAN2 620.

Using the above-referenced example, if the domain name is not listed in the DNS-PBR list 410, the network device 120 may use the default outbound route of WAN1 610. Thus, the routing policy on which a routing decision is based may be a default routing policy. In contrast, if the domain name is listed in the DNS-PBR list 410, the network device 120 may add an outbound route with a gateway of WAN2 620 in the routing table 420. As a result, the network device 120 may connect to the IP address using the outbound route of WAN2 620.

When the source device 110 receives the DNS response 315 from the network device 120, the source device may connect to the IP address associated with the inputted domain name through the network device. The routing decision made by the network device 120, e.g., the outbound route used, to connect to the IP address may depend on the routing policy that corresponds to domain name. To this point, when connecting to the IP address, the network device 120 may use its standard routing lookup processes, e.g., accessing the routing table 420, to determine an outbound route from the source device 110 to the IP address destination. In the case where “www.example.com” is listed in the DNS-PBR list 410, due to the new route added in the routing table 420 via DNS-PBR, the outbound route will use WAN2 620. Thus, the request, response, and page load of “www.example.com” to the user's web browser, e.g., source device 110, may have occurred through the DNS-PBR configured route of WAN2 620. Ultimately, the user, e.g., source device 110, would receive the “www.example.com” page content in their browser, as expected.

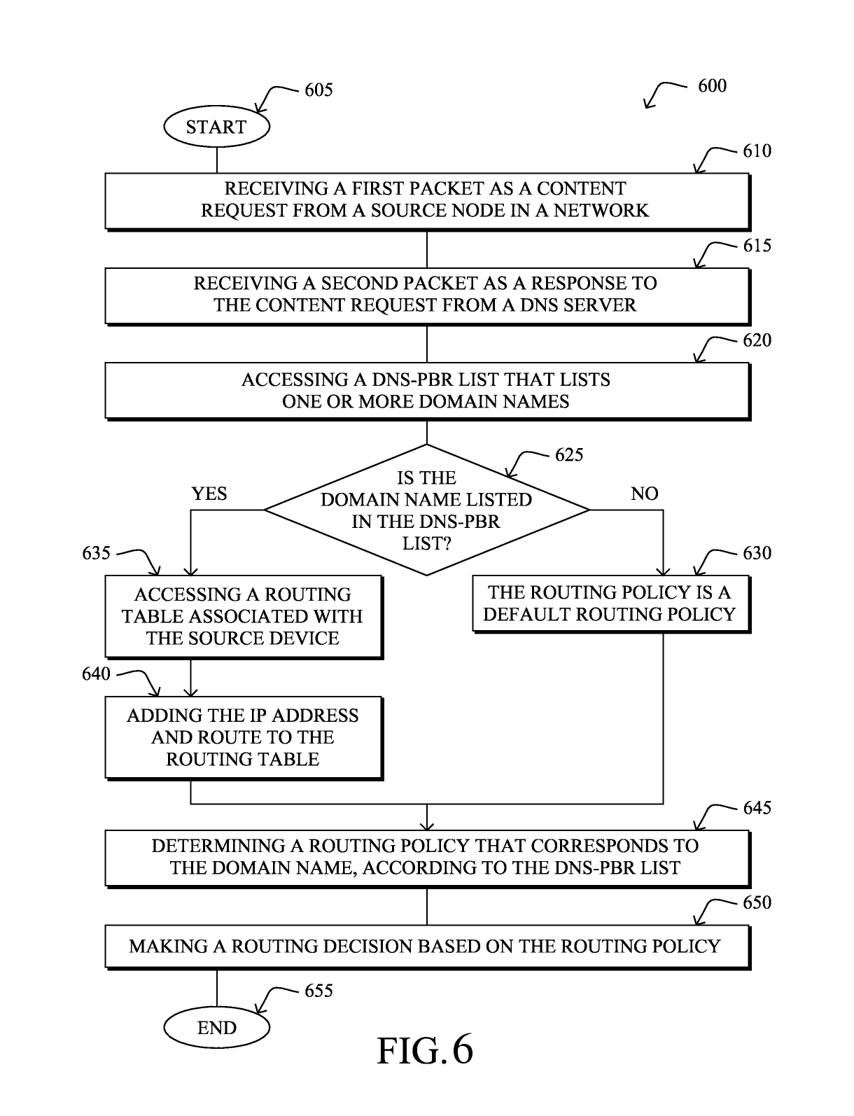

FIG. 6 illustrates an example simplified procedure for routing data based on a naming service in the communication network. As shown in FIG. 6, the procedure 600 may start at step 605, continue to step 610, and so forth, where, as described in greater detail above, routing decisions are made based on a DNS-PBR protocol in a computer network.

At Step 610, the procedure 600 includes receiving a first packet as a content request from a source device in a network. The first packet identifies a domain name. At Step 615, a second packet is received as a response to the content request from a DNS server. The second packet identifies an IP address associated with the domain name. At Step 620, a DNS-PBR list that lists one or more domain names is accessed. The DNS-PBR list defines a routing policy based on a corresponding listed domain name. The routing policy may involve, for example, an outbound route from the source device to the IP address. At Step 625, it is determined whether the domain name is listed in the DNS-PBR list. If the domain name is not in the DNS-PBR list, the procedure 600 continues to Step 630, which sets the routing policy as a default routing policy. On the other hand, if the domain name is in the DNS-PBR list, the procedure 600 continues to Step 635, where a routing table associated with the source device is accessed. At Step 640, the IP address and a corresponding route from the source device to the IP address are added to the routing table. Then, at Step 645, a routing policy that corresponds to the domain name, according to the DNS-PBR list, is determined. At Step 650, a routing decision is made based on the routing policy. As described above, the making of the routing decision may include determining an outbound route from the source device to the IP address. The procedure 600 illustratively ends in step 655. The techniques by which the steps of procedure 600 are performed, as well as ancillary procedures and parameters, are described in detail above.

It should be understood that the steps shown in FIG. 6 are merely examples for illustration, and certain steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for Internet destinations to be reliably routed based on the requirements of the network administrator, without needing to know any additional information about the remote destination apart from the public domain name. For example, with respect to the webpage “www.example.com,” local network entities may know nothing about its technical architecture, whether the IP address(es) ever change, and if so, how often. The webpage may use a content distribution network to hold most of its content, or host its webpage applications on a 3rd party cloud-based server, in which case, its IP address(es) may change by the second. With the disclosed embodiments, however, no knowledge of IP changes made by the remote party is necessary. Instead, a branch office or corporate internet breakout can benefit from the same level of simplicity, and manage specific policy-based routes to remote locations which may be under the control of other departments or authorities.

While there have been shown and described illustrative embodiments that provide for routing data based on a naming service, it is to be understood that various other adaptations and modifications may be made within the spirit and scope of the embodiments herein. For example, the embodiments have been shown and described herein primarily with relation to routers acting as network devices. However, the embodiments in their broader sense are not as limited, and may, in fact, be used with other types of edge devices, such as branch office routers and firewalls through to larger core or edge devices. The disclosed embodiments may also be applicable to VPN and web filtering technologies, where quick exception-ing of certain sites or internet/internal web locations from a more global tunnel or filtering policy is performed. Further, the techniques for determining outbound routes with DNS-PBR could be applicable to more than making routing decisions, such as marking traffic, e.g., for quality of service purposes.

Moreover, the foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as an apparatus that comprises at least one network interface that communicates with a network, a processor coupled to the at least one network interface, and a memory configured to store program instructions executable by the processor. Further, it is expressly contemplated that the components and/or elements described herein can be implemented as software being stored on a tangible, non-transitory computer-readable medium (e.g., disks/CDs/RAM/EEPROM/etc.) having program instructions executable by a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving a first packet as a content request from a source device in a network, the first packet identifying a domain name;
receiving a second packet as a response to the content request from a domain name system (DNS) server, the second packet identifying an Internet Protocol (IP) address associated with the domain name;
accessing a DNS policy-based routing (DNS-PBR) list that lists one or more domain names, wherein the DNS-PBR list defines a routing policy based on a corresponding listed domain name;
determining a routing policy that corresponds to the domain name, according to the DNS-PBR list; and
making a routing decision based on the routing policy.

2. The method according to claim 1, wherein the making of the routing decision comprises:
determining an outbound route from the source device to the IP address based on the routing policy.

3. The method according to claim 1, wherein the routing policy involves an outbound route from the source device to the IP address.

4. The method according to claim 1, further comprising:
determining whether the domain name is listed in the DNS-PBR list, wherein
when the domain name is not listed in the DNS-PBR list, the routing policy is a default routing policy.

5. The method according to claim 4, further comprising, when the domain name is listed in the DNS-PBR list:
accessing a routing table associated with the source device; and
adding, to the routing table, the IP address and a corresponding route from the source device to the IP address.

6. The method according to claim 5, further comprising:
adding, to the routing table, a time-to-live (TTL) value associated with the corresponding route.

7. The method according to claim 5, wherein:
the default routing policy defines a route that uses a primary external wide area network (WAN) gateway, and
the corresponding route uses a secondary external WAN gateway.

8. The method according to claim 4, wherein the determining of whether the domain name is listed in the DNS-PBR list comprises:
inspecting the first packet and second packet to determine the domain name.

9. The method according to claim 1, further comprising:
transmitting the first packet to the DNS server; and
transmitting the second packet to the source device.

10. An apparatus, comprising:
one or more network interfaces that communicate with a network;
a processor coupled to the one or more network interfaces and configured to execute a process; and
a memory configured to store program instructions which contain the process executable by the processor, the process comprising:
receiving a first packet as a content request from a source device in the network, the first packet identifying a domain name;
receiving a second packet as a response to the content request from a DNS server, the second packet identifying an IP address associated with the domain name;
accessing a DNS-PBR list that lists one or more domain names, wherein the DNS-PBR list defines a routing policy based on a corresponding listed domain name;
determining a routing policy that corresponds to the domain name, according to the DNS-PBR list; and
making a routing decision based on the routing policy.

11. The apparatus according to claim 10, wherein the making of the routing decision comprises:
determining an outbound route from the source device to the IP address based on the routing policy.

12. The apparatus according to claim 10, wherein the routing policy involves an outbound route from the source device to the IP address.

13. The apparatus according to claim 10, wherein the process further comprises:
determining whether the domain name is listed in the DNS-PBR list, wherein
when the domain name is not listed in the DNS-PBR list, the routing policy is a default routing policy.

14. The apparatus according to claim 13, wherein the process further comprises, when the domain name is listed in the DNS-PBR list:
accessing a routing table associated with the source device; and
adding, to the routing table, the IP address and a corresponding route from the source device to the IP address.

15. The apparatus according to claim 14, wherein the process further comprises:
adding, to the routing table, a time-to-live (TTL) value associated with the corresponding route.

16. The apparatus according to claim 14, wherein:
the default routing policy defines a route that uses a primary external WAN gateway, and
the corresponding route uses a secondary external WAN gateway.

17. The apparatus according to claim 13, wherein the determining of whether the domain name is listed in the DNS-PBR list comprises:
inspecting the first or second packet to determine the domain name.

18. The apparatus according to claim 10, wherein the process further comprises:
transmitting the first packet to the DNS server; and
transmitting the second packet to the source device.

19. A tangible non-transitory computer readable medium storing program instructions that cause a computer to execute a process, the process comprising:
receiving a first packet as a content request from a source device in a network, the first packet identifying a domain name;
receiving a second packet as a response to the content request from a domain name system (DNS) server, the second packet identifying an Internet Protocol (IP) address associated with the domain name;
accessing a DNS-PBR list that lists one or more domain names, wherein the DNS-PBR list defines a routing policy based on a corresponding listed domain name;
determining a routing policy that corresponds to the domain name, according to ii the DNS-PBR list; and
making a routing decision based on the routing policy.

20. The computer readable medium according to claim 19, wherein the making of the routing decision comprises:
determining an outbound route from the source device to the IP address based on the routing policy.
